(19) United States
(12) Patent Application Publication
(10) Pub. No.: US 2023/0000711 A1
(43) Pub. Date: Jan. 5, 2023

(54) ACTUATORS FOR ASSISTIVE WEARABLE DEVICES

(71) Applicant: X Development LLC, Mountain View, CA (US)

(72) Inventors: Antonio Raymond Papania-Davis, Oakland, CA (US); Erik Lamers, Pittsburgh, PA (US)

(21) Appl. No.: 17/364,681

(22) Filed: Jun. 30, 2021

(51) Int. Cl. A61H 3/00; B25J 9/00

(52) U.S. Cl. CPC A61H 3/00; B25J 9/0006; A61H 2201/165; A61H 2003/007; A61H 2201/1276; A61H 2201/1215; A61H 2201/14; A61H 2201/5025; A61H 2201/5061; A61H 2201/164

(57) ABSTRACT

This application relates to an actuation system for assistive wearable devices such as exoskeletons designed to actuate a joint of a wearer of the device. The actuation system includes a differential pulley drum having a first drum portion and a second drum portion, the first drum portion and the second drum portion having different radii. The differential pulley drum is located at a first end of the actuator. The actuation system further includes a motor coupled to the differential pulley drum and configured to rotate the differential pulley drum, a second pulley located at a second end of the actuator, a flexible sleeve that extends between the differential pulley drum and the second pulley, and a strand that extends from the differential pulley drum to the second pulley through the flexible sleeve.

### TECHNICAL FIELD

This disclosure relates to actuation systems for assistive wearable devices such as exoskeletons.

### BACKGROUND

Exoskeletons are wearable devices that are typically designed to assist a wearer with movement, for example, by providing force, stability, and balance to supplement a wearer's own capabilities. Exoskeletons can enhance the function of different joints in the body, such as an ankle, a knee, or an elbow. For example, an exoskeleton can include an actuator configured to transmit torque to the joint in order to actuate it.

### SUMMARY

This specification describes an actuation system for exoskeletons and other wearable assistive devices, including actuation systems that use a differential pulley drum (e.g., a differential windlass) to selectively apply force to actuate a joint of a wearer's body.

By utilizing the differential pulley drum, the actuation system described in this specification allows for highly customizable transmission ratios without gears (e.g., by adjusting the radius of one part of the differential pulley drum relative to the other part) and for significantly more freedom in the design of the actuation system. Accordingly, the actuation system can be applicable to different joints of a wearer's upper and lower body, and it can accommodate different body types and force delivery requirements.

The actuation system can include a motor coupled to the differential pulley drum and configured to be placed at one side of the joint, a pulley or other guide member to be placed at the other side of the joint, a flexible sleeve extending from the differential pulley drum to the pulley, and a strand that extends through the flexible sleeve around the guide member to form a loop. The strand can be wound around the differential pulley drum. By engaging the motor to rotate the differential pulley drum and shorten the length of the un-wound strand loop, the actuation system can control the tension in the strand loop and consequently the force pulling up on the pulley. The flexible sleeve can freely conform to the body. This arrangement can be used to provide actuation for a shoulder, an ankle, knee, elbow, wrist, or other joint.

Many conventional exoskeletons feature mechanical systems that are bulky, heavy, difficult to use, and lead to large penalties for metabolic cost of transport. For example, current actuation strategies require compression sheaths and rigid structures alongside the strand to maintain compressive reaction forces, which increase the overall weight of the system, add nonlinear effects in the force transmission and decrease controllability.

By contrast, the assistive device described in this specification includes active components arranged on one side of the joint, and only a passive guide member arranged on the other side of the joint, which makes it substantially lightweight and comfortable to wear. For example, when used with an ankle, the guide member can be a pulley coupled to the back of the wearer's foot, so that winding strand around a differential pulley drum at the upper portion of the system pulls up on the back of the foot. In this case, the motor, the differential pulley drum, battery, control electronics, sensors, and other components can be placed at the upper shin, while the pulley is coupled to a wearer's shoe. This places most of the mass of the actuation system, and especially the heaviest components such as the motor assembly and the differential pulley drum, relatively high on the body (e.g., less distal). This provides good metabolic efficiency and comfort, since efficiency is heavily penalized by mass the further down the leg it goes. Moreover, the assistive device can feature a flexible sleeve with a spring, allowing for substantially low profile and flexible form factor that can conform to the body and minimize strand slacking.

Further, currently known exoskeletons often require artificial joint components in addition to the biological joints in order to assist with the desired plane of movement. Accordingly, they can restrict the freedom of movement of the joint in directions other than the direction in which the joint is being actuated. For example, mechanically applying ankle flexion restricts inversion/eversion and internal/external rotation of the foot.

The assistive device described in this specification can use the joint of the wearer's body without a separate, artificial joint that can interfere with or restrict natural movement of the patient's joint. For example, when used with the ankle, coupling the guide member to the back of the wearer's foot and delivering tension to the strand that forms a loop around the guide member allows to pull up on the back of the foot such that the wearer's biological joint, the ankle, is actuated and no bulky or restrictive components hinder other natural movement of the ankle. The assistive device can induce plantarflexion and/or dorsiflexion (e.g., flexion and extension of the ankle) without restricting inversion and eversion (e.g., side-to-side movements that roll the sole of the foot medially and laterally) and without restricting medial and lateral rotation of the ankle (e.g., internal rotation and external rotation).

Lastly, traditional spool actuators (e.g., actuators having a single spool and a single cable winding around the spool) have a lower limit on the spool radius, which is dictated by the strength of the spool material and the tension forces in the cable, and significantly limits the customization and freedom of actuator design.

By contrast, the assistive device described in this specification is not limited by the spool radius, is highly customizable, and allows for a high rotary-to-linear transmission (e.g., the ratio of the rotation of the differential pulley drum and the displacement of the strand connected to the pulley).

Particular implementations of the subject matter described in this disclosure can be implemented so as to realize, but are not limited to, one or more of the following advantages. For example, the assistive device can have a low profile, and being substantially flexible, compliant, lightweight, and comfortable, while maintaining the ability to effectively assist with natural movements of the wearer's body without unduly restricting them. Further, the device may use the biological joint without the need for any artificial joints (e.g., hinges integrated as part of the overall mechanical system. Further, the device can freely conform to the curves of the wearer's body and can be highly customizable.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIG. 1A illustrates a human wearing an example ankle joint assistive device according to a first implementation.

FIG. 1B illustrates a human wearing an example knee joint assistive device according to the first implementation.

FIG. 2A illustrates the medial view of an example assistive device according to the first version.

FIG. 2B illustrates the rear view of an example assistive device according to the first implementation.

FIG. 2C illustrates the lateral view of an example assistive device according to the first implementation.

FIG. 3A illustrates a cross-section of a first implementation of flexible sleeve.

FIG. 3B illustrates a cross-section of a second implementation of flexible sleeve.

FIG. 3C illustrates a cross-section of a third implementation of flexible sleeve.

FIG. 4 illustrates the rear view of an example assistive device according to a second implementation.

FIG. 5A illustrates the side view of an example assistive device according to a third implementation.

FIG. 5B illustrates the rear view of an example assistive device according to the third implementation.

FIG. 6A illustrates the side view of an example assistive device according to a fourth implementation.

FIG. 6B illustrates the rear view of an example assistive device according to the fourth implementation.

Like reference numbers and designations in the various drawings indicate like elements.

### DETAILED DESCRIPTION

The assistive device described in this specification effectively converts the rotation of a differential pulley drum into actuation of a joint of a wearer's body. By varying the radius of one portion of the drum relative to the other, the linear-to-rotary transmission can be customized, which allows to accommodate different joints of a wearer's body, body types and force delivery requirements. The heaviest components of the system, such as the motor assembly and the differential pulley drum, can be placed relatively high on the body (e.g., less distal), thereby reducing metabolic cost of transport. Housing the strand within a flexible sleeve allows the assistive device to freely conform to the curves of a wearer's body and minimize slacking of the strand. Placing the active components on one side of the joint and only a passive guide member on the other allows for freedom of movement of the joint in directions other than the direction in which it is being actuated.

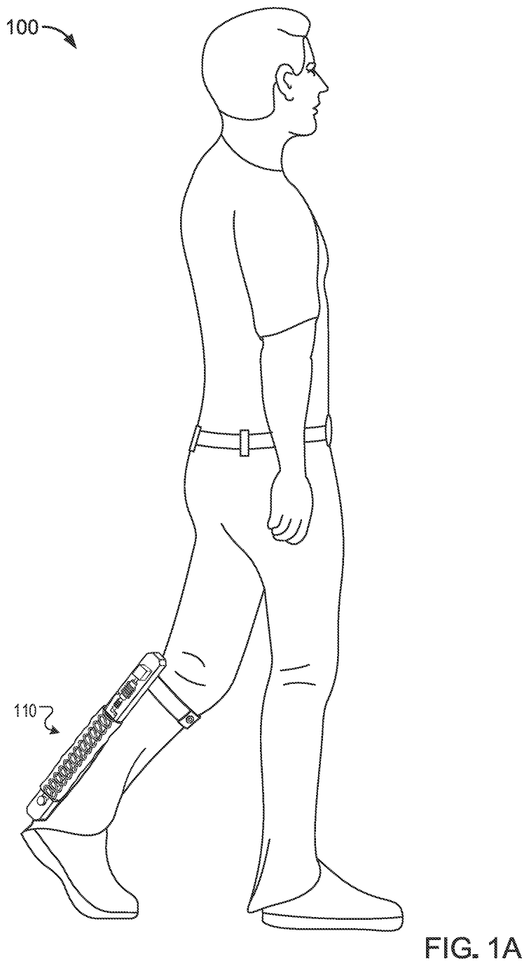

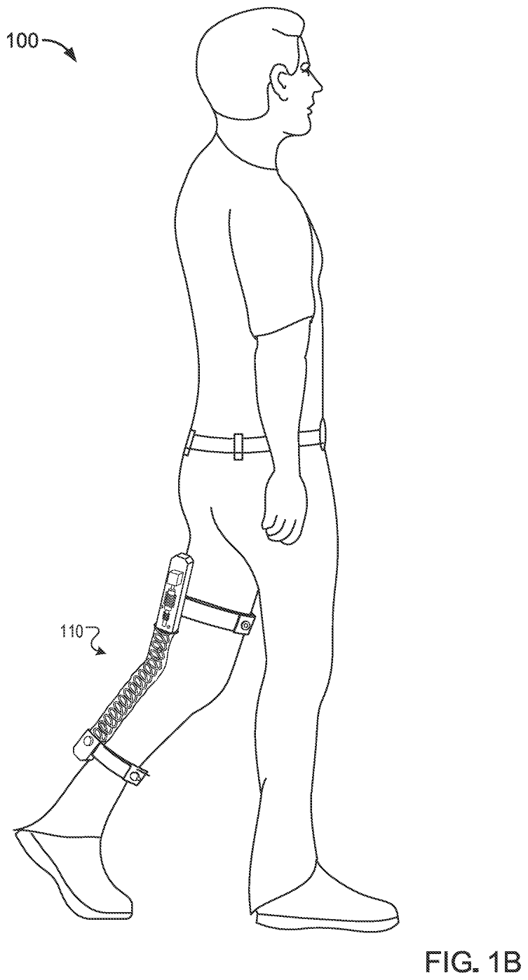

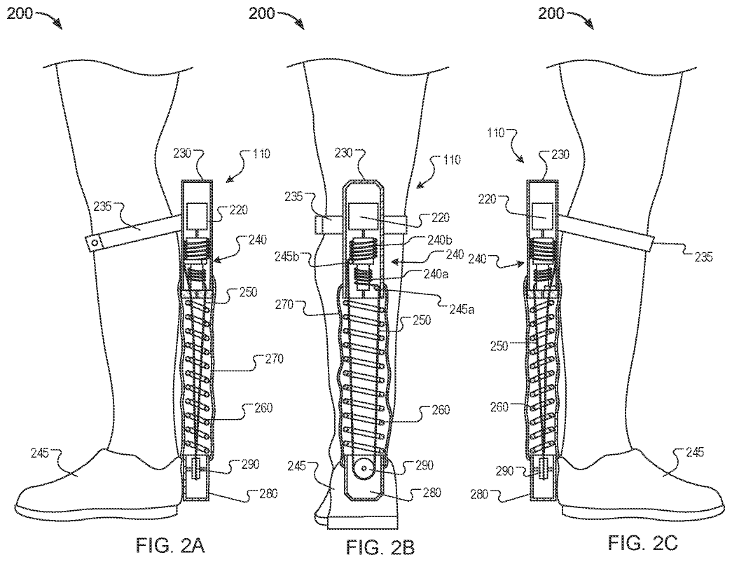

FIG. 1A shows a human 100 wearing an example assistive device according to a first implementation, an assistive device 110 in this example. The structural components of the first implementation of the assistive device 110 will be described in more detail below with reference to FIGS. 2A, 2B, and 2C. The assistive device 110 may be worn on the lower limb in order to assist the wearer 100 with the actuation of the ankle joint during walking. For example, the assistive device 110 may deliver torque to the ankle joint to induce plantar flexion of the foot (extension of the ankle) at each step. Specifically, the rotation of a differential pulley drum (not shown) of the assistive device can be effectively converted into activation of the joint. Advantageously, the differential pulley drum can be designed in such a way so as to effectively accommodate the actuation of a joint with a low degree of flexion (e.g., an ankle, in this case). For example, by varying the radius of one drum portion relative to the other, the rotary-to-linear transmission can be customized to suit a particular joint. Further, the assistive device 110 can have substantially low profile, e.g., the components of the assistive device 110 can conform freely to the body, and it can be comfortably worn over or under clothes.

In another implementation, FIG. 1B shows a human 100 wearing an example assistive device 110 according to the first implementation, but in this implementation the assistive device 110 is worn on the lower limb in order to assist the wearer 100 with the actuation of the knee joint during walking. For example, the actuator 110 in FIG. 1B may deliver torque to the knee joint to induce flexion of the joint at each step. As described above with reference to FIG. 1A, the rotation of a differential pulley drum (not shown) of the assistive device can be effectively converted into actuation of the joint. However, in the example of FIG. 1B, the assistive device 110 delivers torque to a knee joint, i.e., a joint with a high degree of flexion. Advantageously, the rotary-to-linear transmission of the differential pulley drum can be customized to accommodate joints with a high degree of flexion as well. Furthermore, the assistive device 110 includes a flexible sleeve (not shown) that can freely bend and conform to the body even when the knee is flexed to a high degree (e.g., to approximately 140 degrees). The flexible sleeve (not shown) can house a strand that extends through a resilient member inside the flexible sleeve and connects the active components arranged on one side of the joint and a passive guide pulley on the other. When the knee is flexed to a high degree, the resistance of the strand against the resilient element inside the sleeve is increased, which, in turn, decreases the amount of power delivered by the motor.

The components of four different implementations of the assistive device (110, 210, 310, and 410) are described below. While the first implementation of the assistive device 110, illustrated in FIGS. 1A and 1B, is shown as being worn on the lower limb, all four implementations (110, 210, 310, and 410) may be applicable to other joints of both the upper and the lower body such as, but not limited to, an elbow joint, a shoulder joint, a wrist joint, etc. Further, all four different implementations (110, 210, 310, and 410) include a guide member, such as a pulley, coupled to a first attachment portion which may be placed on the wearer's body at one side of the joint, and active components, including the differential pulley drum, placed on the other side of the joint. The pulley may function together with the strand and the active components of the assistive device to provide the force to actuate the joint in such a way that the freedom of movement of the joint in other directions is preserved. Further, all four implementations (110, 210, 310, and 410) may include a differential pulley drum having a first portion with a first drum radius and a second portion with a second drum radius. Since the rotary-to-linear transmission in the differential pulley drum depends on the difference between the first drum radius and the second drum radius, it may be easily and effectively customized by simply changing the radius of one of the drums relative to the other. This, in turn, makes the assistive device highly customizable and compliant. Further, all four implementations (110, 210, 310, and 410) include a flexible sleeve that houses the strand, allowing for a low profile and flexible form factor that may easily conform to the body.

FIGS. 2A, 2B and 2C show medial, rear, and lateral views, respectively, of an example assistive device 110 according to a first implementation. The assistive device 110 is worn across an ankle joint on the leg 200 of a wearer and can be engaged to apply force to actuate the ankle joint.

The actuator 110 can expand and contract to vary the force and distance between an upper attachment portion 235 and a lower attachment portion 280. The actuator 110 applies force between the attachment portions 235, 280 using a motor, a differential pulley drum, and a strand 250 that extends between the attachment portions 235, 280, and is wound around the differential pulley drum 240. The motor 220 and the differential pulley drum 240 include a common axis of rotation such that, when the motor 220 engages, it rotates the differential pulley drum 220, which, in turn, increases (or decreases) a tension in the strand, thereby shortening (or lengthening) the loop of the strand 250. When the loop of the strand 250 is shortened, the force in the strand 250 is converted to a linear motion of the lower attachment portion 280 towards the upper attachment portion 235, thereby actuating the ankle joint.

The differential pulley drum 240 may have a first drum portion 240a and a second drum portion 240a. The first drum portion 240a may have a different radius from the second drum portion 240b (e.g., radius of the first drum portion 240a may be smaller than the radius of the second drum portion 240b). The motor 220 may rotate the differential pulley drum 240 in a clockwise, or anticlockwise, direction.

The strand 250 can be wound around the differential pulley drum 240. In one example, the strand 250 may have a first part wound around the first portion 240a of the differential pulley drum 240, and a second part wound around the second portion 240b of the differential pulley drum 240.

In yet another example, the strand 250 may be wound around the first portion 240a of the differential pulley drum in one direction (e.g., clockwise) and around the second portion 240b of the differential pulley drum 240 in the opposite direction (e.g., anticlockwise). The strand 250 may be a flexible element such as a cable, a belt, a strip, a string, a filament, a thread, etc. The strand 250 may wrap helically around the differential pulley drum 240 (e.g., if the strand 250 is a cable), or the strand 250 may wrap radially around the differential pulley drum 240 (e.g., if the strand 250 is a belt). In the latter implementation, allowing the strand 250 to wrap radially around the differential pulley drum 240 may allow for a more compact form factor of the actuator 110. In some implementations, the strand 250 is made of steel, or an artificial fiber.

The assistive device 110 may further include a pair of guides 245a and 245b (e.g., pulleys, which may be the same as the pulley 290) coupled to the differential pulley drum 240. For example, the first guide 245a may be coupled to the first drum portion 240a and the second guide 245b may be coupled to the second drum portion 240b. The first guide 245a may receive a first part of the strand 250 from the first drum portion 245a, the first part of the strand travelling in a direction substantially perpendicular to the longitudinal axis of the flexible sleeve 270, and redirect the strand in a direction towards the lower attachment portion 280 (e.g., towards the pulley 290). Similarly, the second guide 245b may receive a second part of the strand 250 from the second drum portion 245b, the second part of the strand travelling in a direction substantially perpendicular to the longitudinal axis of the flexible sleeve 270, and redirect the strand in a direction towards the lower attachment portion 28 (e.g., towards the pulley 290). In this way, the first part of the strand 250 and the second part of the strand 250 may travel in a substantially the same direction towards the pulley 290. 245a, 245b. Although a pair of guides 245a, 245b are illustrated in FIGS. 2A, 2B, and 2C, the assistive device 110 may include any number of guides. The differential pulley drum 240 may receive and release a portion of the strand 250 in response to the operation of the motor 220. For example, the motor 220 may rotate the differential pulley drum 240 and the strand 250 may be released from the first portion 240a of the differential pulley drum 240 and received by the second portion 240b of the differential pulley drum 240. A position encoder coupled to, or integrated with, the motor 220, may determine a position of the motor 220 or a component coupled to the motor 220. The actuator 200 may also include a load sensor integrated with the motor 220 and coupled to the strand 250.

The motor 220 and the differential pulley drum 240 may be arranged in a housing 230 that may be coupled to a first attachment portion 235 arranged on one side of the joint. In some implementations, the motor 220 (e.g., the shaft of the motor 220) can be arranged in series with the differential pulley drum 240. For example, as illustrated in FIGS. 2A, 2B, and 2C, for an ankle joint assistive device, they may be arranged just below the knee. The first attachment portion 235 may hold the components on the leg via frictional forces. In some implementations, the load sensor is coupled to the housing 230, the differential pulley drum 240, and/or a guide 290. The load sensor may be configured to measure a load on the strand at a position remote from the position of the load sensor, e.g., measure a load on the strand at a position that is proximal to the other components of the actuator 110.

The active components handling power and data (the motor 220 with integrated load cell and position encoder, and the differential pulley drum 240) may be arranged in the housing 230 that is substantially flat, so that they lay flat against the leg 200 to minimize protrusion. The assistive device 200 may further include the guide 290 (e.g., a pulley) arranged on a second attachment portion 280 on the other side of the joint, which may also lay flat against the body to minimize protrusion. Arranging the components of the actuator 110 in such a way so as to minimize protrusion with respect to the leg 200 may give the actuator 110 overall a substantially low profile and make it comfortable to wear. Since the active components are arranged on one side of the joint with only the passive pulley 290 on the other, the distal mass may be reduced, which has larger penalties for metabolic cost of transport. The second attachment portion 280 may consist of a relatively stiff component so as to minimize the deformation of the shoe in response to the applied force and maximize the effective mechanical work delivered to the ankle.

The assistive device 110 may further include a flexible sleeve 270 extending between the differential pulley drum 240 and the pulley 290 (e.g., extending from one side of the joint to the other side of the joint). The sleeve 270 may be made from a substantially flexible material, such as fabric, so that it is able to bend and freely conform to the curves of the leg 200. In one example, the flexible sleeve 270 may be attached to the housing 230 on one side of the joint and attachment portion 280 on the other side of the joint. In the first implementation of the actuator 110, as illustrated in FIGS. 2A, 2B, and 2C, the axis of rotation of the differential pulley drum 240 may extend through the flexible sleeve 270.

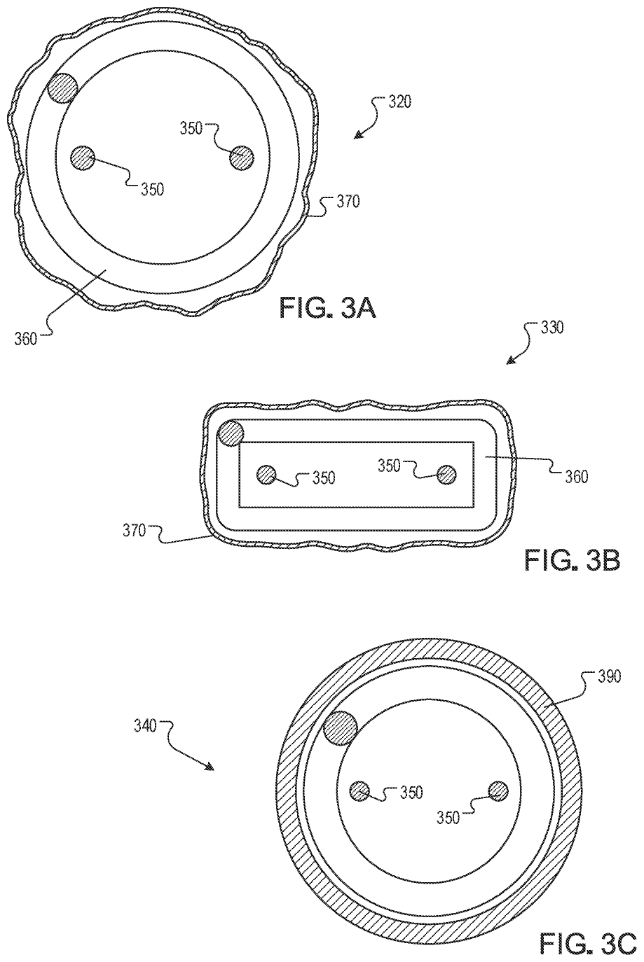

The assistive device 110 may further include a resilient element 260 extending from the differential pulley drum 240 and the pulley 290, and located within the flexible sleeve 270. The resilient element may be a spring, or any other element capable of storing elastic energy, and it may be made of metal, or fatigue resistant thermoplastic. The resilient element 260 may be coupled to the strand 250 (e.g., the strand 250 may extend through the resilient element 260 in the flexible sleeve 270) and it may apply compressive force to the strand 250 between the differential pulley drum 240 and the pulley 290 to maintain the strand 250 under tension. In this way, the strand 250 may be easily kept taught to avoid snagging, and arranged closer to the body to avoid protrusion, allowing for substantially low profile and convenience of wear of the actuator 110. In some implementations, the resilient element 260 can be coupled to the housing 230 and/or the lower attachment portion 280. Different configurations of the flexible sleeve 270, the resilient element 260, and the strand 250 will be described in more detail below with reference to FIGS. 3A, 3B, and 3C.

The strand 250 may extend from the differential pulley drum 240 to the guide member 290 (i.e., the pulley 220) and form a loop around the guide member 290. The strand 250 may connect the motor 220, and the differential pulley drum 240, arranged on one side of the joint, and the pulley 290 arranged on the other side of the joint. For example, the cable 230 may form a loop between the active components and the pulley 290. The motor 220 may rotate the differential pulley drum 240 to increase tension in the strand 250 (e.g., to shorten the loop of the strand 250) which may transmit force to the biological joint (e.g., ankle joint, in the implementation shown in FIGS. 2A, 2B, and 2C) and thereby actuate it. In other words, when the motor 220 rotates the differential pulley drum 240, the strand 250 moves along the pulley 290 and tension increases. The tension in the stand 250 is transmitted to the foot as an upward force at the heel where the pulley 290 is attached. The force translates into a torque of the ankle joint such that the heel moves upward in the direction of the force and the toes of the foot move in the opposite direction. Since the strand 250 is arranged as a loop around the pulley 290, the joint may move freely out of the main plane of actuation. For example, ankle plantar flexion may be applied lifting the heel while not affecting the foot ability to move freely in the yah and roll axis.

In one example, the pulley 290 may be a rolling wheel pulley, such that the strand 250 is able to travel along with the rolling wheel. The axis of rotation of the pulley 290 may be substantially perpendicular to the axis of rotation of the joint. In another example, the pulley 290 may be a guide pulley with a channel, such that the cable is able to slide in the channel. The guide may be made using low friction plastic such as, but not limited to, Ultra High Molecular Weight Polyethylene plastic. The strand 250 may slide in the slippery plastic groove of the guide pulley 290. Having a passive pulley transmitting force to the biological joint negates the need for mechanically powered artificial joints, which significantly minimizes the overall physicality of the assistive device 110.

All implementations of the assistive device (11, 210, 310, 410) may include a high-level controller (not shown), which may determine the course of action, and a low-level controller (not shown), which may determine how the course of action is achieved. The low-level controller may determine the desired force to be applied to the strand at all times to keep it under constant tension. The load sensor may measure the torque due to movement. In response to the measurement, the low-level controller may send a signal to the motor to rotate the differential pulley drum and thereby shorten or lengthen the strand loop. In this way, the active components of the assistive device may form a closed control feedback loop.

FIGS. 3A, 3B, and 3C illustrate a cross-sectional view of three different implementations (320, 330, 340) of a flexible sleeve. Any of the three implementations (320, 330, 340) can be included with any of the four implementations of the assistive device (110, 210, 310, 410).

FIG. 3A illustrates a cross-sectional view of a first implementation 320 of the flexible sleeve 370, where the flexible sleeve 370 includes a resilient element 360. As described above, the flexible sleeve can be made of a flexible material, such as fabric, and the resilient element 360 can be made of metal, thermoplastic, or polymer, and can be disposed within the flexible sleeve 370. A strand 350 can extend through the resilient element 360 and the flexible sleeve 370. The resilient element 360 can be a spring, or any other element that can store elastic energy. The spring can be a compression spring, or any other type of spring. The spring can be designed from a round wire, or a rectangular wire (e.g., as in a die spring). As shown in FIG. 3A, the resilient element 360 can have a circular cross-section perpendicular to the longitudinal axis of the resilient element 360.

FIG. 3B illustrates a cross-sectional view of a second implementation 330 of the flexible sleeve 370, where the flexible sleeve 370 includes a resilient element 360. This implementation is similar to the one described above with respect to FIG. 3A, but the resilient element has a rectangular cross-section perpendicular to the longitudinal axis of the resilient element 360.

FIG. 3C illustrates a cross-sectional view of a third implementation 340 of the flexible sleeve 390. In this implementation 340, the flexible sleeve 390 is a corrugated polymer (e.g., thermoplastic) tube that can store elastic energy. The flexible sleeve 390 can include a resilient element, similarly as described above with respect to the first implementation 320 and the second implementation 330, or it can be provided without the resilient element. The strand 350 can extend through the flexible sleeve 390. The flexible sleeve 390 can be used when the assistive device is worn across a joint that does not naturally require a high degree of flexion (e.g., an ankle joint) which, in turn, would not require a high degree of bending of the flexible sleeve 390 and the strand 350 contacting the walls of the flexible sleeve 390.

The second 210, third 310, and fourth 410, implementations of the assistive device will be described in more detail next.

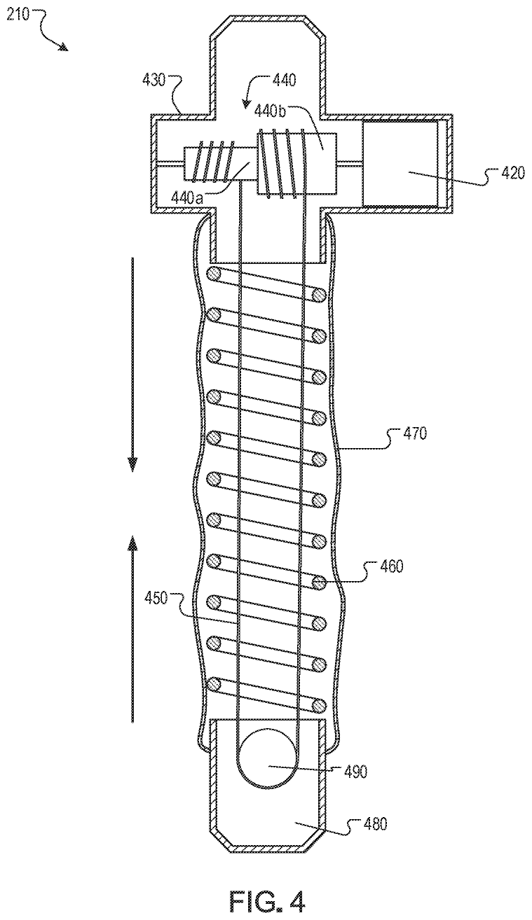

FIG. 4 illustrates an example assistive device 210 according to a second implementation. This implementation differs from the first implementation shown in FIGS. 2A, 2B, and 2C by having the axis of rotation of the differential pulley drum 440 arranged transverse (e.g., perpendicular) to the longitudinal axis of the flexible sleeve 470. Otherwise, the second implementation 210 includes the same components as described above in respect of the first implementation 110.

As shown in FIG. 4, the motor 420 is coupled to the differential pulley drum 440 having two drum portions 440a and 440b with different radii. These components are arranged in a housing 430. The strand 450 winds around the first drum portion 440a and the second drum portion 440b, extends through a flexible sleeve 470 and a resilient element 460 to the pulley 490, and forms a loop around the pulley 490 that is attached to a lower attachment portion 480. In operation, the assistive device 210 performs the same function as described above with respect to the first implementation, with the only difference that the axis of rotation of the motor 420 and the differential pulley drum 440 is transverse to the longitudinal axis of the flexible sleeve 470.

The second implementation of the assistive device 210 may allow for a more compact form factor since the active components are arranged transverse to the longitudinal axis of the sleeve. For example, if the assistive device 210 is arranged on a lower limb for actuation of the ankle joint, then the active components can be placed in front of the sheen, thereby having low profile and minimizing protrusion. Furthermore, because the first part of the strand 450 and the second part of the strand 450, wound around the first drum portion 440a and the second drum portion 440b, respectively, both extend from the differential pulley drum 440 in a direction parallel to the longitudinal axis of the flexible sleeve 470, the parts of the strand do not need to be redirected by guides, as is the case with the first implementation of the assistive device 110 described above. Therefore, the strand 450 of the second implementation of the assistive device 210 encounters less friction than the strand 250 of the first implementation 110. Further, the second implementation 210 is structurally simpler than the first 110.

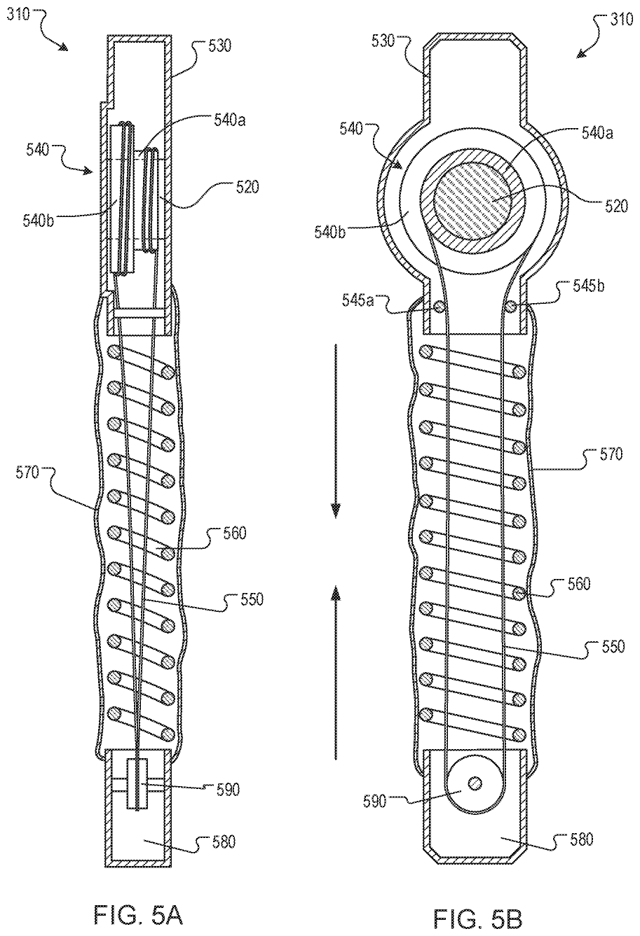

FIGS. 5A and 5B illustrate side view and lateral view, respectively, of an example assistive device 310 according to a third implementation. The components of the third implementation are the same as the components described above in relation to the first and the second implementation of the assistive device. However, in the third implementation, the motor 520 is arranged concentrically with the differential pulley drum 540. For example, the differential pulley drum 540 may completely surround the motor 520. More specifically, the differential pulley drum 540 may have two drum portions 540a and 540b having different radii, such that the drum portion having the smaller radii 540a surrounds the motor 520, and the drum portion having the larger radii 540b surrounds the drum portion having the smaller radii 540b, with all three components having a common axis of rotation.

As shown in FIGS. 5A and 5B, the motor 520 and the differential pulley drum 540 are provided in a housing 530. The assistive device 310 may further include a pair of guides 545a and 545b coupled to the differential pulley drum 540, which may be similar guides as described above with reference to FIGS. 2A, 2B, and 2C, and the first implementation 110 of the assistive device. The guides 545a, 545b may be attached to the housing 530 and may direct the strand 550 towards the longitudinal axis of the flexible sleeve 570 (e.g., towards the pulley 590 that is attached to a second attachment portion 580). Specifically, the first guide 545a can receive a first portion of the strand 550 from the first drum portion 540a and direct it inside the flexible sleeve 570 and towards the pulley 590. Similarly, the second guide 545b can receive a second portion of the strand 550 from the second drum portion 540b and direct it inside the flexible sleeve 570 towards the pulley 590. In this implementation, the strand 550 can be, e.g., a belt, such that it is able to wrap on itself, and the first part of the strand 550 and the second part of the strand 550 are able to radially wrap around the first drum portion 540a and the second drum portion 540b, respectively. Therefore, this implementation of the assistive device 310 can be more compact than the implementations described above.

The motor 520 can turn the first drum portion 540a and the second drum portion 540b and the concentric rotation of the drum portions 540a, 540b can shorten or lengthen the loop of the strand 550 between the differential pulley drum 540 and the pulley 590. Each drum portion 540a, 540b is able to let out, or take in, the strand 550, which depends on the direction of rotation of the drum portions 540a, 540b. For example, when the drum portions 540a, 540b, rotate in one direction (e.g., clockwise), the first drum portion 540a can let out the strand 550, and the second drum portion 540b can take in the strand. When the drum portions 540a, 540b rotate in the opposite direction (e.g., anticlockwise), the first drum portion 540a can take in the strand 550 and the second drum portion 540b can let out the strand 550. When the loop of the strand 550, arranged between the differential pulley drum 540, and the pulley 590, is shortened, the tension of the strand 550 is converted into an upward force on the pulley 590 and the second attachment portion 580 that the pulley is attached to. This force, in turn, causes the pulley 690 and the second attachment portion 680 to move towards the differential pulley drum 630, thereby actuating a joint of a body of a wearer of the assistive device 310.

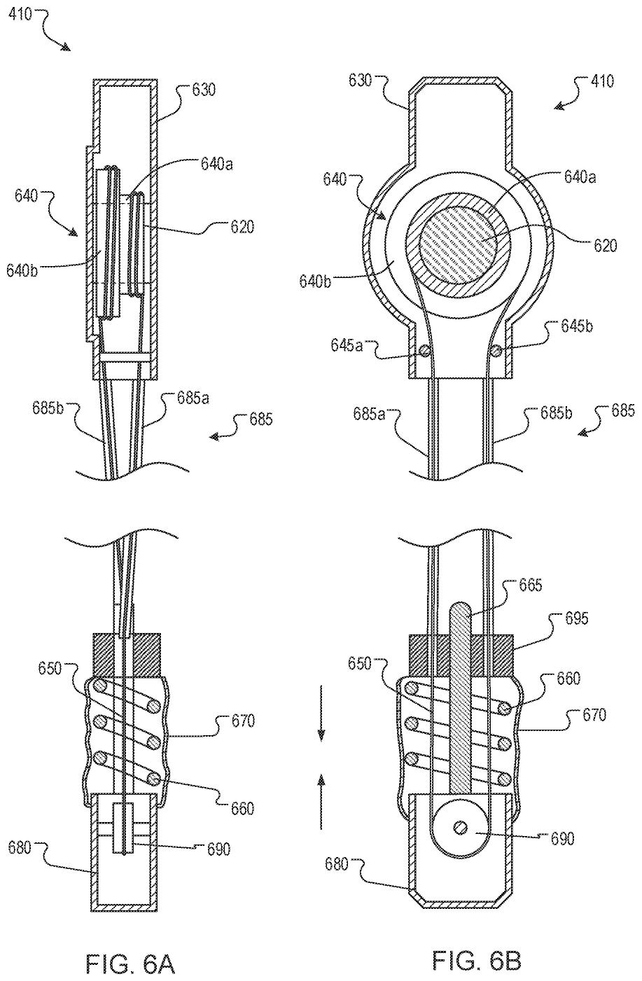

FIGS. 6A and 6B illustrate side view and lateral view, respectively, of an example assistive device 410 according to a fourth implementation. This implementation is similar to the one described above with reference to FIGS. 5A and 5B. Specifically, this implementation also includes a motor 620 that is arranged concentrically with the differential pulley drum 640 (having two drum portions 640a and 640b with different radii) and disposed in a housing 630. A pair of guides 645a and 645b are coupled to the housing 630 and direct a strand 650 towards the pulley 690 in a similar way as described above. The motor 620 rotates the first drum portion 640a and the second drum portion 640b to either shorten or lengthen the loop of the strand 550 between the differential pulley drum 540 and the pulley 690, thereby either increasing or decreasing an upward force on the pulley 690, respectively. The fourth implementation also includes a pair of guide members 645a, 645b, that are attached to the housing 630, as described above with reference to FIGS. 5A and 5B. The guide members 645a, 645b direct a first part of the strand 650 and a second part of the strand 650 towards the pulley 690.

The fourth implementation 410 is similar to all implementation described above in that it also includes a flexible sleeve 670 with a resilient element 660 and a strand 650 extending through these components and towards a guide member 690 (e.g., a pulley 690) that is attached to a second attachment portion 680.

However, the fourth implementation further includes a bowden cable 685 coupled to the flexible sleeve 670 at a middle attachment portion 695, and to the housing 630. The bowden cable 685 can include a first bowden cable portion 685a and a second bowden cable portion 685b that extend from the housing 630 towards the flexible sleeve 670. The first part of the strand 650, that is wound around the first drum portion 640a and is directed by the first guide member 645a towards the pulley 690, can be positioned inside, and extend through, the first bowden cable portion 685a. Similarly, the second part of the strand 650, that is wound around the second drum portion 640b and is directed by the second guide member 645b towards the pulley 690, can be positioned inside, and extend through, the second bowden cable portion 685b.

The bowden cable 685 effectively extends the total length of the assistive device 410. This, in turn, can allow arranging the active components (the motor 620 and the differential pulley drum 640) of the assistive device 410 remotely from the point of actuation of the joint (e.g., on the waist of a wearer, when the device 410 is arranged to actuate the ankle of the wearer's body). For example, an ankle joint could be powered by motors mounted on the thigh or waist allowing for more configuration flexibility and less distal mass. Further, the bowden cable 685 section of the assistive device 410 can be placed over highly curved areas of the body in order to reach distal parts of the body (e.g., a wrist) while keeping the active components proximal (e.g., mounted at the waist).

The fourth implementation of the assistive device 410 can further include a linear guide pin 665 attached to the lower attachment portion 680 and the middle attachment portion 695 and extending through the flexible sleeve 670. The guide pin 665 can be made of a rigid material (e.g., a metal) and it can provide stiffness to the flexible sleeve 670. However, the fourth implementation of the assistive device 410 can also be implemented without the guide pin 665.

The controller and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the subject matter have been described. Other embodiments are within the scope of the following claims.

1. An actuator for an assistive device comprising:
a differential pulley drum having a first drum portion and a second drum portion, the first drum portion and the second drum portion having different radii, wherein the differential pulley drum is located at a first end of the actuator;
a motor coupled to the differential pulley drum and configured to rotate the differential pulley drum;
a second pulley located at a second end of the actuator;
a flexible sleeve that extends between the differential pulley drum and the second pulley; and
a strand that extends from the differential pulley drum to the second pulley through the flexible sleeve, wherein the strand forms a loop around the second pulley, the strand having a first part wound around the first drum portion and a second part wound around the second drum portion, the motor being configured to rotate the differential pulley drum to increase tension in the strand to actuate a joint of a body of a wearer of the assistive device.

2. The actuator of claim 1, further comprising a resilient element located within the flexible sleeve.

3. The actuator of claim 2, wherein the resilient element is coupled to the strand and configured to apply a force between the differential pulley drum and the second pulley so as to maintain tension in the strand.

4. The actuator of claim 2, wherein the resilient element is a compression spring and the strand extends through the compression spring.

5. The actuator of claim 2, wherein the resilient element is a die spring and the strand extends through the die spring.

6. The actuator of claim 2, wherein the resilient element is made of metal, thermoplastic, or polymer.

7. The actuator of claim 2, wherein the resilient element has a circular cross-section perpendicular to the longitudinal axis of the resilient element.

8. The actuator of claim 2, wherein the resilient element has a rectangular cross-section perpendicular to the longitudinal axis of the resilient element.

9. The actuator of claim 2, wherein the flexible sleeve is a corrugated polymer tube, and the resilient element is integrated with the corrugated polymer tube.

10. The actuator of claim 1, wherein the strand is a cable configured to wind helically around the differential pulley drum.

11. The actuator of claim 1, wherein the strand is a belt configured to wrap radially around the differential pulley drum.

12. The actuator of claim 1, further comprising a load sensor coupled to the strand.

13. The actuator of claim 1, further comprising a position encoder configured to determine a position of the motor or a component coupled to the motor.

14. The actuator of claim 1, wherein the motor is arranged in series with the differential pulley drum, and wherein the axis of rotation of the differential pulley drum extends through the flexible sleeve.

15. The actuator of claim 1, wherein the motor is arranged in series with the differential pulley drum, and wherein the axis of rotation of the differential pulley drum is transverse to the longitudinal axis of the flexible sleeve.

16. The actuator of claim 1, wherein the motor is arranged concentrically with the differential pulley drum, and wherein the differential pulley drum completely surrounds the motor.

17. The actuator of claim 1, further comprising one or more guides coupled to the differential drum, wherein the one or more guides are configured to direct the strand towards the longitudinal axis of the flexible sleeve.

18. The actuator of claim 1, further comprising a first attachment coupled to the motor, and a second attachment coupled to the second pulley, wherein the first attachment and the second attachment are configured to be placed on opposite sides of the joint of the wearer's body.

19. The actuator of claim 1, further comprising a bowden cable coupled to the flexible sleeve and the motor, and arranged between the flexible sleeve and the motor.

20. The actuator of claim 1, further comprising a linear guide pin coupled to the flexible sleeve.
